(19) United States
(12) Patent Application Publication
(10) Pub. No.: US 2006/0251328 A1
(43) Pub. Date: Nov. 9, 2006

(54) Apparatus and method for extracting moving images

(75) Inventor: Deok-hee Boo, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/416,074

(22) Filed: May 3, 2006

(30) Foreign Application Priority Data
May 4, 2005 (KR) 2005-37469

(51) Int. Cl. G06K 9/68; G06K 9/34

(52) U.S. Cl. 382/220; 382/173

(57) ABSTRACT

An apparatus and method for automatically extracting and outputting an image including a desired object from a moving image file, where the moving image extracting apparatus includes: a reference image processor pre-processing a reference image and extracting features of the reference image; a frame information setting unit setting a sampling rate and a similar frame output rate; an image extractor selecting candidate frames from input moving images at the sampling rate, extracting features of the candidate frames, matching the extracted features of the reference image with the extracted features of the candidate frames to calculate similarities thereof, and selecting at least one frame with a similarity greater than a threshold value from the candidate frames; a frame buffer storing the frame selected by the image extractor; and a data converter converting the frame stored in the frame buffer into printable data.

### CROSS-REFERENCE TO RELATED APPLICATION

This application claims the benefit of Korean Patent Application No. 2005-37469, filed May 4, 2005, in the Korean Intellectual Property Office, the disclosure of which is incorporated herein by reference.

### BACKGROUND OF THE INVENTION

1. Field of the Invention

An aspect of the present invention relates to an apparatus and method for extracting moving images, and more particularly, to an apparatus and method for automatically extracting and outputting an image including a desired object from a moving image file.

2. Description of the Related Art

The development of information communication technologies has lead to the Internet rapid increase of the amount of multimedia information, such as characters, sounds, still and moving images and so on, circulated via the internet and other digital media. Moving images generally include computer-generated images, animations, images created by camcorders or mobile phones, etc. These images can be easily distributed and, recently, many users want to directly output them without storing them. Thus, a screen capture utility is installed on a PC and a desired screen is captured many times. However, different from the case of still images, a process of capturing, extracting, and printing a desired screen, from moving image screens including dozens of frames per second, is very difficult and time-consuming.

FIG. 1 is a block diagram of a conventional moving image outputting apparatus.

Referring to FIG. 1, a moving image transmission terminal 110 transmits moving image data to a moving image outputting apparatus 120. The moving image transmission terminal 110 may be a PC, a PDA (Personal Digital Assistant), or a mobile device such as a mobile phone. Before sending moving image data, the moving image transmission terminal 110 sends a PJL (Printer Job Language) message informing that data to be sent is moving image data, to the moving image outputting apparatus 120, in order to allow the moving image outputting apparatus 120 to process the moving image data. Here, the PJL message can include information, such as the type of a key frame extraction algorithm to be applied to the moving image outputting apparatus 120, the maximum number of output frames, and so on.

The moving image outputting apparatus 120 includes a moving image receiver 121 receiving moving image data, an image extractor 122 extracting a key frame, a data converter 123 converting the extracted key frame data into printable data, and a printing unit 124 printing the converted printable data.

The image extractor 122 receives a moving image stream from the moving image receiver 121 and transmits data extracted in real time from the moving image stream to the data converter 123. The image extractor 122 compares and analyzes image data of each received frame with a reference frame to calculate characteristic values, sets a frame with a characteristic value greater than a predetermined threshold value to a key frame, and then outputs the key frame. The key frame is a significantly meaningful one of the frames of the moving images. In general, a frame representing a scene transition is extracted as the key frame. An algorithm for extracting a key frame includes a method of using brightness differences between pixels, a method of using brightness information, a method of using a brightness histogram of entire frames, etc.

However, these methods are difficult, expensive, and time-consuming since they may extract images undesired by a user and must compare all frames with a reference frame in order to extract a key frame.

### SUMMARY OF THE INVENTION

An aspect of the present invention provides an apparatus and method for extracting moving images, capable of automatically extracting and outputting an image including a desired object from moving images when outputting the moving images through a printer.

According to an aspect of the present invention, there is provided a moving image extracting apparatus including: a reference image processor pre-processing a reference image and extracting features of the reference image; a frame information setting unit setting a sampling rate and a similar frame output rate; an image extractor selecting candidate frames from input moving images at the sampling rate, extracting features of the candidate frames, matching the extracted features of the reference image with the extracted features of the candidate frames to calculate similarities thereof, and selecting at least one frame with a similarity greater than a threshold value from the candidate frames; a frame buffer storing the frame selected by the image extractor; and a data converter converting the frame stored in the frame buffer into printable data.

According to another aspect of the present invention, the image extractor includes: a candidate frame selector selecting the candidate frames from the input moving images at the sampling rate; a pre-processing and feature-extracting unit pre-processing the candidate frames and extracting the features of the candidate frames; a similarity calculator matching the extracted features of the reference image with the extracted features of the candidate frame to calculate the similarities; and an output frame selector selecting the at least one frame with the similarity greater than the threshold value from the candidate frames and storing the at least one frame in the frame buffer.

According to another aspect of the present invention, if there is a plurality of successive similar images among frames stored in the frame buffer, the output frame selector rearranges the frames using the similarities and selects frames with high similarities from the rearranged frames according to the similar frame output rate.

According to another aspect of the present invention, the image extractor matches the feature-extracted reference image to the feature-extracted candidate frames using a Hausdorff method to calculate the similarities.

According to another aspect of the present invention, the moving image extracting apparatus further includes: a display unit displaying the frame selected by the image extractor to allow a user to determine whether or not to output the frame.

According to another aspect of the present invention, the input moving images are received from a host PC or from an external storage medium.

According to another aspect of the present invention, there is provided a moving image extracting method including: extracting features of a reference image; setting a sampling rate and a similar frame output rate; selecting candidate frames from input moving images at the sampling rate and extracting features of the candidate frames; matching the extracted features of the reference image with the extracted features of the candidate frames to calculate similarities and selecting at least one frame with a similarity greater than a threshold value from the candidate frames; and converting the selected frame into printable data.

According to another aspect of the present invention, the selecting of the at least one frame includes: matching the extracted features of the reference image with the extracted features of the candidate frames to calculate the similarities; and selecting the at least one frame with the similarity greater than the threshold value from the candidate frames and storing the selected frame in a frame buffer.

According to still another aspect of the present invention, there is provided a computer-readable medium having embodied thereon a computer program for executing the method for extracting the moving images.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a conventional moving image outputting apparatus;

FIG. 2 is a block diagram of a moving image extracting apparatus according to an embodiment of the present invention;

FIG. 3 is a block diagram of an image extractor shown in FIG. 2;

FIG. 4 is a flowchart illustrating a moving image extracting method according to an embodiment of the present invention;

FIGS. 5A through 5E show images for illustrating the moving image extracting method according to an embodiment of the present invention; and

FIGS. 6A through 6C show other images illustrating the moving image extracting method according to an embodiment of the present invention.

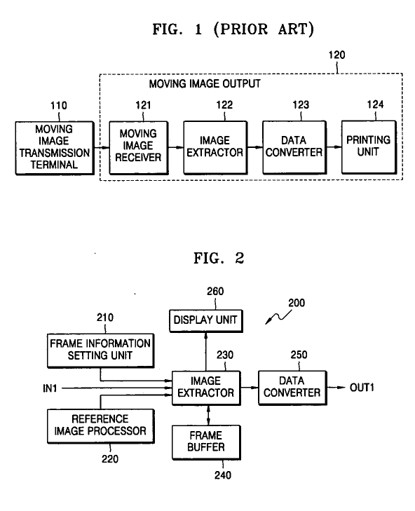

### DETAILED DESCRIPTION OF THE INVENTION

The present invention will now be described more fully with reference to the accompanying drawings, in which exemplary embodiments of the invention are shown.

FIG. 2 is a block diagram of a moving image extracting apparatus 200 according to an embodiment of the present invention.

Referring to FIG. 2, the moving image extracting apparatus 200 includes a frame information setting unit 210, a reference image processor 220, an image extractor 230, a frame buffer 240, and a data converter 250.

The moving image extracting apparatus 200 may be installed in a printer driver device in a PC or in a printer.

The frame information setting unit 210 sets a sampling rate for extracting a predetermined number of frames from moving image data. This process is required to avoid overload, which can be caused when applying feature extraction and image matching to all frames of moving image data having 30 frames per second. Also, the frame information setting unit 210 sets a similar frame output rate for deciding how many similar frames should be extracted when similar images are extracted for successive frames.

The reference image processor 220 processes a reference image including an object desired by a user. The reference image may be a frame of moving image data, a scanned (or sketched) image, an image pre-stored in a PC, etc.

In order to correctly compare the reference image with each frame of moving images, the reference image processor 220 performs image pre-processing for grooming the reference image. The image pre-processing includes re-scaling for adjusting the size of the reference image, masking for eliminating unnecessary backgrounds, illumination gradient correction for adjusting the brightness of the reference image and eliminating the shadows, image enhancement by using an algorithm such as histogram smoothing, etc.

After pre-processing the reference image, the reference image processor 220 extracts features of the pre-processed reference image. Feature extracting technologies used for this process include feature-based, knowledge-based, template-based, and color-based technologies. In this embodiment, an edge detecting technology is used for extracting the features of the reference image.

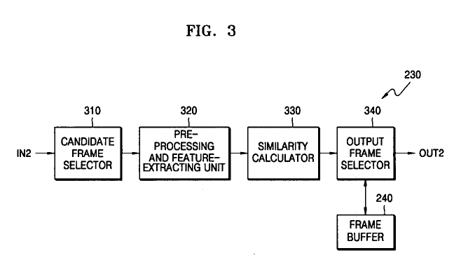

The image extractor 230 randomly selects candidate frames from input moving images IN1 at the sampling rate set by the frame information setting unit 210, extracts features of the selected candidate frames, and matches the extracted features of the candidate frames with the extracted features of the reference image to calculate similarities thereof, and selects at least one frame with a similarity greater than a threshold value from the candidate frames. In this embodiment, in order to calculate a similarity between a reference image and a candidate frame, Hausdorff distance matching is used. The detailed configuration of the image extractor 230 will be described later with reference to FIG. 3.

The frame buffer 240 stores the frame selected by the image extractor 230. The frame buffer 240 also stores the similarities of the respective frames calculated by the image extractor 230.

The data converter 250 converts the frame stored in the frame buffer 240 into printable data OUT1.

A display unit 260 displays the frame selected by the image extractor 230. A user can select whether or not to output the frame displayed by the display unit 260.

FIG. 3 is a block diagram of the image extractor 230.

Referring to FIG. 3, the image extractor 230 includes a candidate frame selector 310, a pre-processing and feature-extracting unit 320, a similarity calculator 330, and an output frame selector 340.

The candidate frame selector 310 selects candidate frames from input moving images IN2 at a predetermined sampling rate. The input moving images IN2 may be moving images stored on a host PC (not shown) or moving images received from an external medium, such as a memory card, a digital camera, a digital camcorder, and so on.

The pre-processing and feature-extracting unit 320 performs pre-processing and feature extraction on the candidate frames. This process is the same as the process performed by the reference image processor 220.

The similarity calculator 330 matches the extracted features of the candidate frames with the extracted features of the reference image to calculate similarities thereof.

The output frame selector 340 selects at least one frame with a similarity greater than a threshold value from the candidate frames and stores the frame in the frame buffer 240. If there is a plurality of successive similar images among frames stored in the frame buffer 240, the output frame selector 340 rearranges the frames using the similarities, selects frames with high similarities from the rearranged frames at a predetermined similar frame output rate, and outputs the selected frames as output frames OUT2.

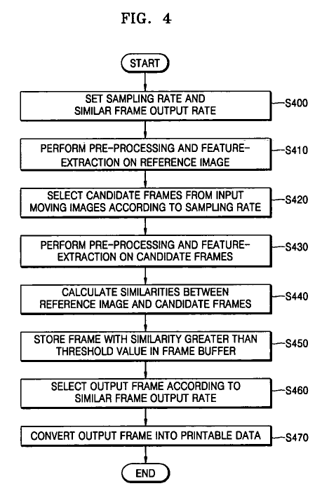

FIG. 4 is a flowchart illustrating a moving image extracting method according to an embodiment of the present invention. The moving image extracting method illustrated in FIG. 4 will be described with reference to FIGS. 2 though 3.

Referring to FIGS. 2 through 4, in operation S400, the frame information setting unit 210 sets a sampling rate and a similar frame output rate on the basis of values input by a user through a user interface. For example, the sampling rate can be set to one among high (80%; by selecting 8 of 10 frames corresponding to a shot as candidate frames), intermediate (50%; by selecting 5 of 10 frames corresponding to a shot as candidate frames), and low (20%; by selecting 2 of 10 frames corresponding to a shot as candidate frames) levels. To allow the user to more correctly find a desired image, the sampling rate can be set to the high level. Also, the similar frame output rate can be set to one among high, intermediate, and low levels.

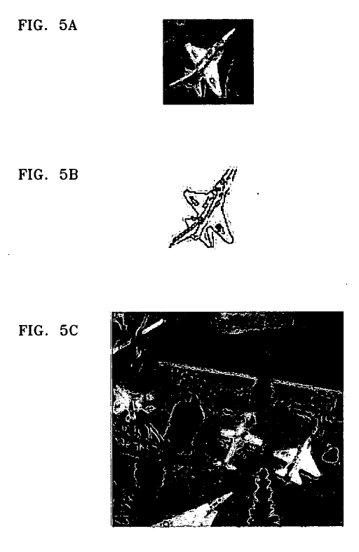

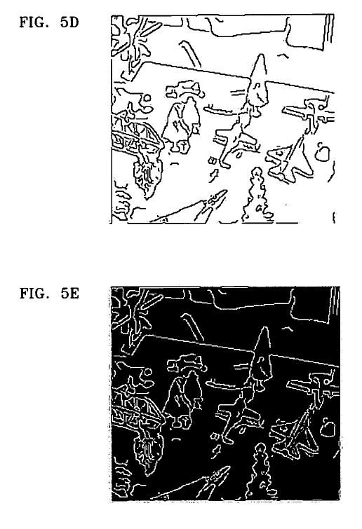

In operation S410, the reference image processor 220 pre-processes a reference image and extracts features of the reference image. An exemplary reference image is shown in FIG. 5A. The reference image may be a user's desired image data pre-stored on a host PC. A resultant image obtained from pre-processing and feature-extracting the reference image of FIG. 5A is shown in FIG. 5B.

In operation S420, the candidate frame selector 310 selects candidate frames from input moving images at the set sampling rate. An exemplary candidate frame is shown in FIG. 5C.

In operation S430, the pre-processing and feature-extracting unit 320 pre-processes the candidate frames and extracts features of the candidate frames. A resultant image obtained from extracting features of the candidate frame of FIG. 5C is shown in FIG. 5D.

In operation S440, the similarity calculator 330 calculates similarities between the candidate frames and the reference image. In this embodiment, in order to calculate a similarity between a reference image and a candidate frame, Hausdorff distance matching is used.

‘Hausdorff distance’ is a distance between a group and a point nearest to the group in another group, where the ‘group’ corresponds to a cluster in a feature-extracted reference image and a feature-extracted candidate frame.

When two groups, A={a₁, . . . , aₘ} and B={b₁, . . . , bₙ}, are provided, a Hausdorff distance between the two groups can be defined by Equation 1.

$$h ( A , B ) = {max}_{a ∈ A} {min}_{b ∈ B} ‖ a - b ‖ \qquad ( 1 )$$

However, due to the asymmetry of the groups A and B, a distance between the groups A and B is different from that between the groups B and A. Accordingly, Equation 1 should be redefined by Equation 2.
H(A,B)=max(h(A,B), h(B,A))

Here, since H(A,B) are values calculated for a cluster of the reference image and respective clusters of the candidate frame, a plurality of Hausdorff distances are obtained. A smallest one of the Hausdorff distances is decided to be a Hausdorff distance between the reference image and the candidate frame. In this embodiment, an inverse number of the decided Hausdorff distance is a similarity.

In operation S450, the output frame selector 340 stores at least one frame with a similarity greater than a threshold value in the frame buffer 240.

In operation S460, if there are a plurality of successive similar images among frames stored in the frame buffer 240, the output frame selector 340 rearranges the frames using the similarities, selects frames with high similarities from the rearranged frames at a predetermined similar frame output rate, and outputs the selected frames as output frames.

An exemplary frame selected as an output frame according to the Hausdorff distance matching is shown in FIG. 5E. The output frame selector 340 selects the output frames and can also store the output frames in the frame buffer 240 once again. The user can determine whether or not to print the output frames stored in the frame buffer 240, using a preview function of the user interface.

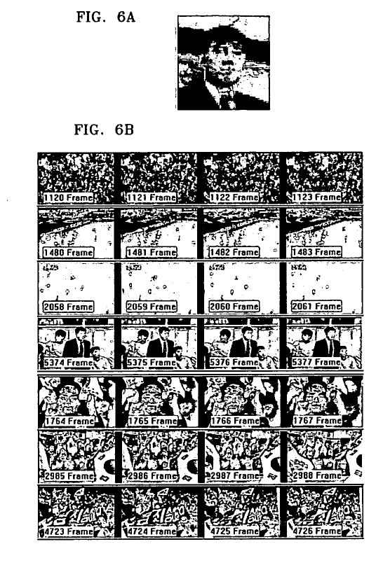

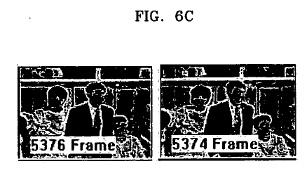

FIGS. 6A through 6C show other images for illustrating the moving image extracting method according to the embodiment of the present invention, wherein FIG. 6A shows a reference image and FIG. 6B shows candidate frames selected according to a sampling rate. Since the candidate frames shown in FIG. 6B are merely exemplary frames used in the embodiment of the present invention, frame numbers denoted on the images are meaningless. FIG. 6C shows final output frames selected among the candidate frames through matching with the reference image, according to a similar frame output rate.

In operation S470, the data converter 250 converts the selected output frames into printable data. The printable data is printed through a printer (not shown).

An aspect of the present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium can also be distributed over network coupled computer systems so that the computer readable code is stored and executed in a distributed fashion. Also, functional programs, codes, and code segments for implementing the aspect of the present invention can be easily induced by programmers in the art.

As described above, according to an aspect of the present invention, by automatically extracting and outputting an image including a desired object when outputting moving images through a printer, it is possible to reduce the time and cost for printing moving images and also provide various selection output options to a user.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A moving image extracting method comprising:
extracting features of a reference image;
setting a sampling rate and a similar frame output rate;
selecting candidate frames from input moving images at the sampling rate and extracting features of the candidate frames;
matching the extracted features of the reference image to the extracted features of the candidate frames to calculate similarities and selecting at least one frame with a similarity greater than a threshold value from the candidate frames; and
converting the selected frame into printable data.

2. The moving image extracting method of claim 1, wherein the selecting of the at least one frame comprises:
matching the extracted features of the reference image to the extracted features of the candidate frames to calculate similarities; and
selecting the at least one frame with the similarity greater than the threshold value from the candidate frames and storing the selected at least one frame in a frame buffer.

3. The moving image extracting method of claim 2, wherein the selecting of the at least one frame further comprises:
if there are a plurality of successive similar images among frames stored in the frame buffer, rearranging the frames using the similarities and selecting at least one frame with a high similarity from the rearranged frames according to the similar frame output rate.

4. The moving image extracting method of claim 1, wherein the similarities are calculated by matching the extracted features of the reference image with the extracted features of the candidate frames using a Hausdorff method.

5. A computer-readable medium having embodied thereon a computer program for executing a moving image extracting method, the method comprising:
extracting features of a reference image;
setting a sampling rate and a similar frame output rate;
selecting candidate frames from input moving images at the sampling rate and extracting features of the candidate frames;
matching the extracted features of the reference image with the extracted features of the candidate frames to calculate similarities thereof and selecting at least one frame with a similarity greater than a threshold value from the candidate frames; and
converting the selected frame into printable data.

6. A moving image extracting apparatus comprising:
a frame information setting unit setting a sampling rate for extracting a predetermined number of frames from input moving images;
a reference image processor processing a reference image selected by a user and extracting features of the reference image;
an image extractor randomly selecting candidate frames from the input moving images at the sampling rate set by the frame information setting unit, extracting features of the selected candidate frames, and matching the extracted features of the candidate frames with the extracted features of the reference image to calculate similarities, and selecting at least one frame with a similarity greater than a threshold value from the candidate frames;
a frame buffer storing the selected frame; and
a data converter converting the stored frame into printable data.

7. The moving image extracting apparatus of claim 6, wherein the frame information setting unit sets a similar frame output rate determining a number of similar frames that are extracted when similar images are extracted for successive frames.

8. The moving image extracting apparatus of claim 6, wherein the reference image includes a frame of moving image data, a scanned image, or an image pre-stored in a PC.

9. The moving image extracting apparatus of claim 6, wherein the reference image processor pre-processes the reference image including re-scaling, masking, illumination gradient correction and image enhancement.

10. The moving image extracting apparatus of claim 6, wherein the features of the reference image are extracted using an edge detecting method.

11. The moving image extracting apparatus of claim 6, wherein Hausdorff distance matching is used to calculate a similarity between the reference image and the candidate frame.

12. The moving image extracting apparatus of claim 6, wherein the frame buffer stores the similarities of the candidate frames calculated by the image extractor.

13. The moving image extracting apparatus of claim 6, wherein the image extractor includes a candidate frame selector, a pre-processing and feature-extracting unit, a similarity calculator and an output frame selector.

14. The moving image extracting apparatus of claim 13, wherein the candidate frame selector selects the candidate frames from the input moving images at the set sampling rate.

15. The moving image extracting apparatus of claim 14, wherein the input moving images include moving images stored on a host PC, moving images received from a memory card, a digital camera or a digital camcorder.

16. The moving image extracting apparatus of claim 14, wherein the similarity calculator compares the extracted features of the candidate frames with the extracted features of the reference image to calculate the similarities.

17. The moving image extracting apparatus of claim 6, wherein the reference image processor extracts features of a pre-processed reference image using a feature-based method, a knowledge-based method, a template-based method, or a color-based method.

18. The moving image extracting apparatus of claim 11, wherein a Hausdorff distance is a distance between a group and a point nearest to the group in another group, where the group corresponds to a cluster in the extracted features of the reference image and the extracted features of the candidate frame.
